(19) United States
(12) Patent Application Publication
(10) Pub. No.: US 2025/0174379 A1
(43) Pub. Date: May 29, 2025

(54) RESISTOR HAVING LOW TEMPERATURE COEFFICIENT OF RESISTANCE

(71) Applicant: CYNTEC CO., LTD., Hsin-chu (TW)

(72) Inventor: RihYang HUANG, Hsin-chu (TW)

(21) Appl. No.: 18/960,527

(22) Filed: Nov. 26, 2024

Related U.S. Application Data
(60) Provisional application No. 63/603,440, filed on Nov. 28, 2023.

(51) Int. Cl. H01C 7/06

(52) U.S. Cl. CPC H01C 7/06

(57) ABSTRACT

A resistor is provided, which comprises: a resistive element; a first conductive element connected to the first side of the resistive element; a second conductive element connected to the second side of the resistive element; and a first extension part connected to the first side of the resistive element, extending in a direction away from the resistive element and spaced apart from the first conductive element; a second extension part connected to the second side of the resistive element, extending in a direction away from the resistive element and spaced apart from the second conductive element; a first sensing point located on the first extension part; and a second sensing point located on the second extension part.

### CROSS-REFERENCE TO RELATED APPLICATION

This application claims priority of No. 63/603,440 filed in U.S.A. on Nov. 28, 2023 under 35 USC 119, the entire content of which is hereby incorporated by reference.

### BACKGROUND OF THE INVENTION

### Field of the Invention

The present invention relates to a resistor, and in particular to a resistor having a relatively low temperature coefficient of resistance.

### Background of the Invention

When existing automotive shunts or resistors are used for current sensing, as the operating temperature rises due to power-on, the sensed resistance will increase due to the temperature drift effect of the copper terminals, resulting in an increase in current sensing errors. A resistive element of a resistor is usually formed from a resistive strip placed between two conductive strips. The conductive strip is typically formed from copper sheet. The thickness of the copper sheet is usually chosen based on the desired power dissipation of the component and the desired mechanical strength. The conductive strip is formed of copper. Copper has a temperature coefficient of resistance (TCR) of 3900 ppm/° C., whereas resistive element may have a TCR of less than 100 ppm/° C. Due to the large amount of copper placed in the current path of the resistor. The resistor has a very high positive TCR.

U.S. Pat. No. 8,198,977B2 discloses a resistor with temperature coefficient of resistance (TCR) compensation. The above patent discloses a resistor formed by a resistive strip disposed between two conductive strips. The conductive strips of the resistor are formed with two main terminals and two extension portions. The extension portions are extended from the conductive strip and the voltage sensing point is disposed at their end. During operation, the two main terminals carry most of the current flowing through the resistor. Since the extension portions extend from the conductive strip, there is a first notch provided them. However, the extension portions and the main terminal are still electrically connected via the conductive strip (first notch edge). In such a structure, the position of the voltage sensing point will easily affect the error amount of voltage detection. In other words, the positional deviation of the voltage sensing point caused by welding or manufacturing can easily cause the voltage detection error amount to change accordingly. In addition, there is still room for improvement in the temperature coefficient of resistance (TCR) of the above structure.

### SUMMARY OF THE INVENTION

An object of the present invention is to provide a resistor with a relatively low temperature coefficient of resistance compared to the prior art, thereby reducing the voltage detection error amount affected by the position of the voltage sensing terminals. To achieve the above object, an embodiment of the present invention provides a resistor, which comprises: a resistive element; a first conductive element connected to the first side of the resistive element; a second conductive element connected to the second side of the resistive element; and a first extension part, connected to the first side of the resistive element, extending in a direction away from the resistive element and spaced apart from the first conductive element; a second extension part connected to the second side of the resistive element, extending in a direction away from the resistive element and spaced apart from the second conductive element; a first sensing point, located on the first extension part; and a second sensing point, located on the second extension part.

In one embodiment, the first conductive component and the first extension part are welded to the first side of the resistive element, and the second conductive component and the second extension part are welded to the second side of the resistive element. The welding structure on the resistive element between the first conductive element and the first extension part is partially or completely removed. The welding structure on the resistive element between the second conductive element and the second extension part is partially or completely removed.

In one embodiment, a first welding structure is formed between the resistive element and the first conductive element, a third welding structure is formed between the resistive element and the first extension part, and a first middle welding structure is connected between the first welding structure and the third welding structure. A second welding structure is formed between the resistive element and the second conductive element, a fourth welding structure is formed between the resistive element and the second extension part, and a second middle welding structure is connected between the second welding structure and the fourth welding structure. The first middle welding structure or/and the second middle welding structure includes at least one groove, and the at least one groove faces a direction away from the resistive element.

In one embodiment, a first welding structure is formed between the resistive element and the first conductive element, a third welding structure is formed between the resistive element and the first extension part, and the first welding structure is spaced apart from the third welding structure, and a second welding structure is formed between the resistive element and the second conductive element, a fourth welding structure is formed between the resistive element and the second extension part, and the second welding structure is spaced apart from the fourth welding structure. A first notch or/and a second notch are located respectively on both sides of the resistive element, and the first notch and the second notch correspond to the first gap and the second gap respectively.

In one embodiment, a first gap is formed between the first extension part and the first conductive element, and a second gap is formed between the second extension part and the second conductive element. In one embodiment, preferably, the width of the first gap and the second gap may be in the range of 1.0˜3.5 mm respectively.

In one embodiment, the resistive element has a groove formed on the first edge of the resistive element. In one embodiment, the first conductive element is formed with a first locking hole, and the second conductive element is formed with a second locking hole.

In one embodiment, the first extension part and the second extension part are respectively bent toward the normal direction of the surface of the first conductive element or the second conductive element.

In one embodiment, the first sensing point and the second sensing point are pin. In one embodiment, the resistor further includes a conductive frame and an electrical insulation housing which form a connector. The conductive frame includes a first conductive lead-out structure and a second conductive lead-out structure. The first end of the first conductive lead-out structure is joined to the first extension part serves as the first sensing point; the first end of the second conductive lead-out structure is joined to the second extension part serves as the second sensing point. The electrical insulation housing is disposed on the surface of the middle part of the resistive element and forms a hollow shape. The electrical insulation housing defines an accommodating space, and the second ends of the first conductive lead-out structure and the second conductive lead-out structure are located in the accommodating space of the electrical insulation housing. In one embodiment, the resistor further includes at least one reinforcing structure. One end of the at least one reinforcing structure is fixed to the first conductive member and/or the second conductive member, and the other end of the at least one reinforcing structure is encapsulated and fixed by the electrical insulation housing.

Through the above structure, the resistor of the present invention can effectively reduce the temperature coefficient of resistance and achieve better product characteristics.

### BRIEF DESCRIPTION OF THE DRAWINGS

The disclosure is illustrated by embodiments, depicted by accompanying drawings, and described below. The accompanying drawings are not drawn to scale, depending on standards accepted in related art. For the sake of clear illustration, the dimensions of parts and components shown in the accompanying drawings may be increased or decreased as desired.

FIG. 1 is a perspective view of a resistor according to an embodiment of the present invention.

FIG. 2 is a top view of a resistor according to an embodiment of the present invention.

FIG. 3A is a top view of a resistor according to another embodiment.

FIG. 3B is a top view of a resistor according to another embodiment.

FIG. 4 is a top view of a resistor according to another embodiment.

FIG. 5 is a perspective view of a resistor according to another embodiment.

FIG. 6 is a TCR simulation diagram of resistors of a comparative example and a resistor according to an embodiment of the present invention.

FIG. 7A is a perspective view of a resistor according to another embodiment.

FIG. 7B is a perspective view of a resistor according to another embodiment.

### DETAILED DESCRIPTION OF THE EMBODIMENTS

In the following, the details will be described with reference to the accompanying drawings. The contents in the accompanying drawings also constitute a part of the detailed description of the specification, and are illustrated in a specific description manner that can implement the embodiment. The following embodiments have described sufficient details to enable those skilled in the art to implement the technology. Of course, other embodiments can also be adopted, or any structural, logical, and electrical modifications can be made without departing from the embodiments described in this disclosure. Therefore, the following detailed description should not be regarded as a limitation. On the contrary, the embodiments contained therein will be defined by the scope of the claims. The drawings illustrating the various embodiments of the device are not drawn to scale, and in particular, certain dimensions are for clarity of presentation and are shown exaggeratedly in the drawings.

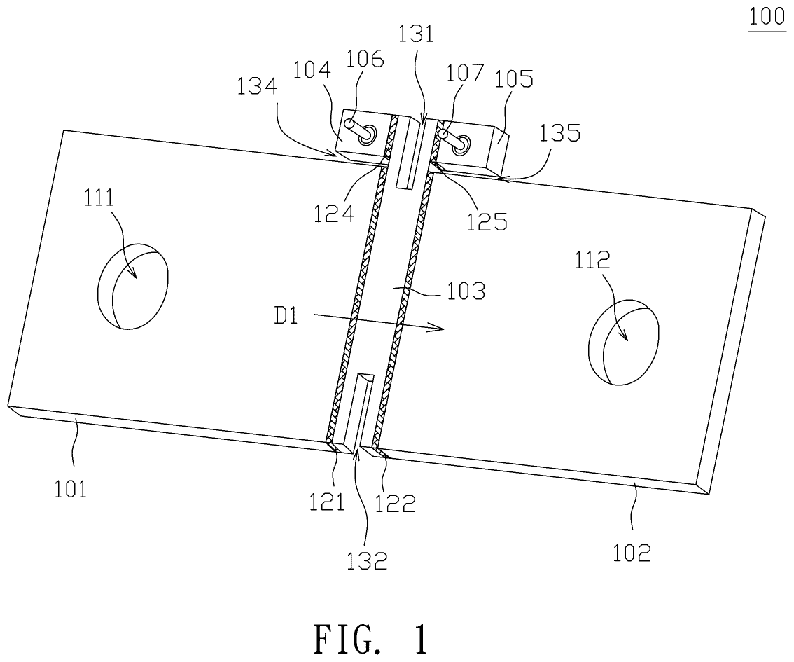

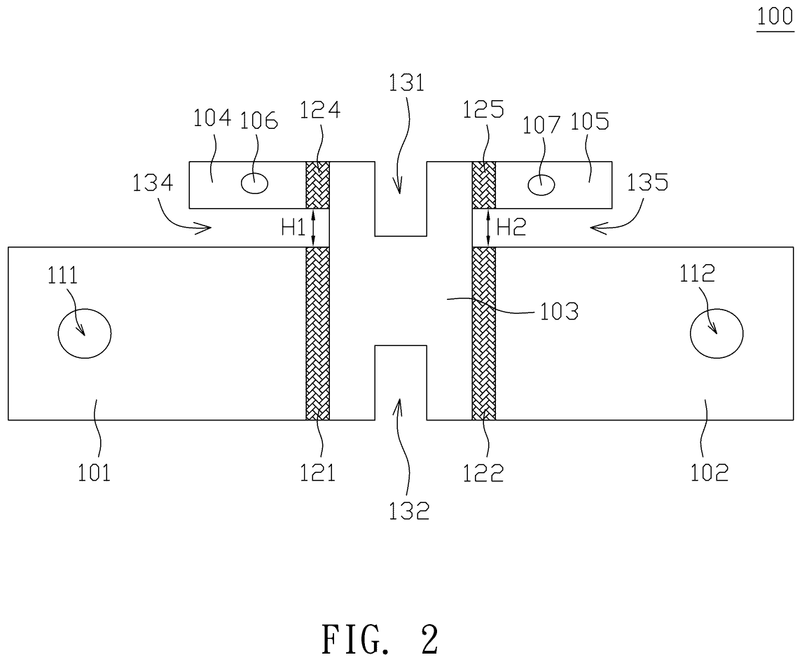

FIG. 1 is a perspective view of a resistor according to an embodiment of the present invention. FIG. 2 is a top view of a resistor according to an embodiment of the present invention. As shown in FIGS. 1 and 2, a resistor 100 with a low temperature coefficient of resistance according to an embodiment of the present invention includes a resistive element 103, a first conductive element 101, a second conductive element 102, a first extension part 104 and a second extension part 105. The resistor 100 defines a main current direction D1 thereon. The first conductive element 101 and the second conductive element 102 may be copper, aluminum or alloy materials of combinations thereof, and the resistive element 103 may be alloy materials of copper-manganese-tin alloy, copper-manganese-nickel alloy, nickel-chromium-aluminum-silicon alloy or combinations thereof. The resistive element 103 is located between the first conductive element 101 and the second conductive element 102. The resistance value or resistivity of the resistive element 103 is more than 10 times greater than the resistance value or resistivity of the first conductive element 101 and the second conductive element 102. As shown in FIGS. 1 and 2, the resistive element 103 protrudes to at least one side of the first conductive element 101 and the second conductive element 102 respectively. Then, the resistive element 103 extends to the first extension part 104 and the second extension part 105, so that the resistive element 103 is connected to the first extension part 104 and the second extension part 105. Preferably, a portion of the first extension part 104 and the second extension part 105 can each respectively serve as voltage sensing terminals.

The first conductive element 101 is connected to the first side of the resistive element 103 in the main current direction D1. The first extension part 104 is connected to the first side of the resistive element 103. The first extension part 104 is located on one side of the first conductive element 101 and does not contact the first conductive element 101. Preferably, a first gap 134 is formed between the first extension part 104 and the conductive elements 101. In this embodiment, preferably, the first gap 134 may be in an elongated shape and the extension direction of the first gap 134 is parallel to the main current direction D1. The distance between the first extension part 104 and the first conductive member 101, that is, the width of the first gap 134 is the interval distance H1. In other embodiments, the first gap 134 may be in an elongated shape and the extension direction of the first gap 134 is not perpendicular to the main current direction D1. Alternatively, the first gap 134 may have any shape. In such embodiment, the interval distance H1 may be the distance between two points where both sides of the first gap 134 (defined by the first extension part 104 and the first conductive element 101) are connected to the resistive element 103.

The second conductive element 102 is connected to the second side of the resistive element 103 opposite to the first side in the main current direction D1. The second extension part 105 is connected to the second side of the resistive element 103. The second extension part 105 is located on one side of the second conductive element 102 and does not contact the second conductive element 102. Preferably, a second gap 135 is formed between the second extension part 105 and the second conductive member 102. In this embodiment, preferably, the second gap 135 may be in an elongated shape and the extension direction of the second gap 135 is parallel to the main current direction D1. The distance between the second extension part 105 and the second conductive element 102, that is, the width of the second gap 135, is the interval distance H2. In other embodiments, the second gap 135 may be in an elongated shape and the extending direction of the second gap 135 is not perpendicular to the main current direction D1. Alternatively, the second gap 135 may have any shape. In such embodiment, the interval distance H2 may be the distance between two points where both sides of the second gap 135 (defined by the first extension part 104 and the first conductive element 101) are connected to the resistive element 103.

In one embodiment, the resistor 100 can fine-tune the TCR performance by adjusting the interval distance H1 and the interval distance H2. When the interval distance H1 and the interval distance H2 increase, the TCR gradually tends towards a negative value. Preferably, the interval distance H1 and the interval distance H2 are in the range of 1.0.˜3.5 mm, so that relatively ideal TCR characteristics can be achieved.

In one embodiment, the joints between the resistive element 103 and the first conductive element 101, the second conductive element 102, the first extension part 104, the second extension part 105, etc. may be a melt bonding performed by a welding process, and a first welding structure 121, a second welding structure 122, a third welding structure 124 and a fourth welding structure 125 are respectively formed. The first welding structure 121 includes the melted and mixed materials of the resistive element 103 and the first conductive element 101. The second welding structure 122 includes the melted and mixed materials of the resistive element 103 and the second conductive element 102. The third welding structure 124 includes the melted and mixed materials of the resistive element 103 and the first extension part 104. The fourth welding structure 125 includes the melted and mixed materials of the resistive element 103 and the second extension part 105.

FIG. 2 is a top view of a resistor according to an embodiment of the present invention. As shown in FIG. 2, the manufacturing method of the resistor 100 according to an embodiment of the present invention is as follows. A resistive element 103, a first conductive element 101, a second conductive element 102, a first extension part 104 and a second extension part 105 are provided. Moreover, after placing the first conductive element 101, the second conductive element 102, the first extension part 104 and the second extension part 105 respectively on the two opposite sides of the resistive element 103, the resistive element 103 is bonded between the first conductive element 101 and the second conductive element 102 and is bonded between the first extension part 104 and the second extension part 105, by using bonding process for example a welding process. According to this manufacturing method, the bottom surface defining the first gap 134 and the second gap 135 is the side of the resistive element 103.

The manufacturing method of the resistor 100 according to an embodiment of the present invention is as follows. Two conductors and a resistive element 103 are provided. A bonding process, for example a welding process, is used to join the resistive element 103 to the conductors, so that the resistive element 103 is bonded between the conductors. Then, the conductors are removed or cut to form the first gap 134 and the second gap 135, and then the first conductive element 101, the second conductive element 102, the first extension part 104 and the second extension part 105 are formed correspondingly. For example, it can be achieved using punch, mechanical cutting process or electro-discharge cutting process. Furthermore, the first middle welding structure 136 between the first conductive element 101 and the first extension part 104 is partially or completely removed. The second middle welding structure 137 between the second conductive element 102 and the second extension part 105 is partially or completely removed.

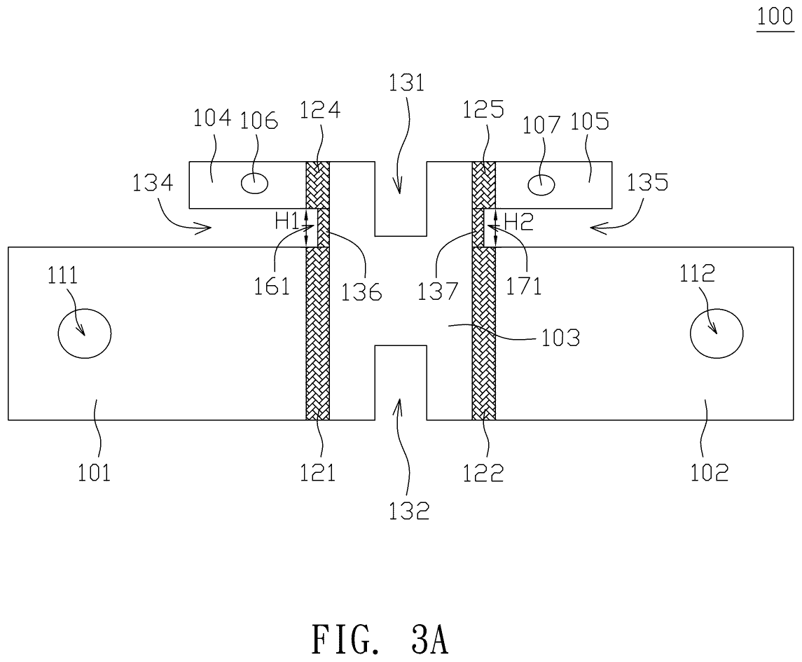

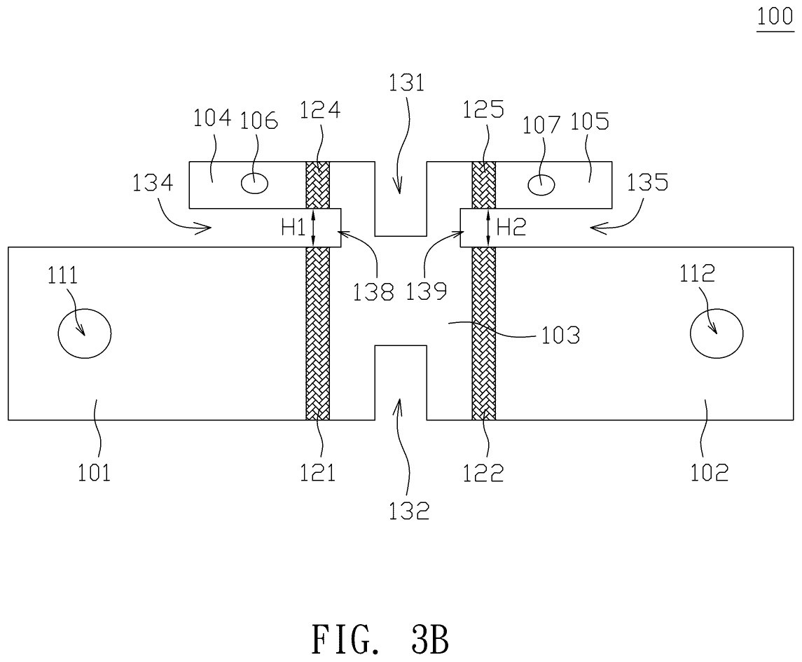

FIG. 3A is a top view of a resistor according to another embodiment. More specifically, when the aforementioned middle welding structure 136 or 137 is partially removed, as shown in FIG. 3A, the bottom surface defining the first gap 134 and the second gap 135 are at least one groove 161, 171 defined by the middle welding structure 136 and/or the middle welding structure 137. The at least one groove 161, 171 extends in a direction away from the resistive element 103. The first middle welding structure 136 is connected between the first welding structure 121 and the third welding structure 124, and the second middle welding structure 137 is connected between the second welding structure 122 and the fourth welding structure 125. FIG. 3B is a top view of a resistor according to another embodiment. When the middle welding structures 136 or 137 is completely removed, as shown in FIG. 2 or 3B, the bottom surface defining the first gap 134 and the second gap 135 is the side of the resistive element 103. In order to remove the middle welding structure 136 or 137 more reliably, as shown in FIG. 3B, a notch 138 or/and 139 is cut into a side of the resistive element 103. The notch 138 or 139 corresponds to the first gap 134 and the second gap 135 respectively, and extends in a direction away from the resistive element 103. These different welding structure designs can provide different electrical characteristics and mechanical strength to meet the needs of different application scenarios.

The aforementioned welding process is not particularly limited as long as the two materials can be melted and mixed together. It may be or include one or more of laser beam welding, electron beam welding and high current (spot) welding, etc. Moreover, the first welding structure 121 is not in direct contact with the third welding structure 124. Preferably, the first gap 134 is located between the first welding structure 121 and the third welding structure 124. In addition to the complete separation of the first welding structure 121 and the third welding structure 124, the first conductive member 101 and the first extending part 104 are also entirely separated. The second welding structure 122 is not in direct contact with the fourth welding structure 125. Preferably, the second gap 135 is located between the second welding structure 122 and the fourth welding structure 125. In addition to the complete separation of the second welding structure 122 and the fourth welding structure 125, the second conductive member 102 and the second extending part 105 are also entirely separated.

As shown in FIGS. 1 and 2, the resistor 100 further includes a first sensing point 106 disposed on the first extension part 104 and a second sensing point 107 disposed on the second extension part 105. When the resistor 100 is connected in series to the battery or current path of the power system, the current to be measured will flow from the first conductive element 101 to the resistive element 103, and then flow out from the second conductive element 102. Subsequently, a corresponding sensing voltage is generated between the first extension part 104 and the second extension part 105. This sensing voltage is equal to the resistance value of the resistor 100 multiplied by the current value of the current to be measured. The current sensing unit (not shown) detects the current value of the current to be measured from the obtained sensing voltage. In one embodiment, the first sensing point 106 and the second sensing point 107 may be pins or tin-containing solder bonding areas.

In the conventional art, pins serving as sensing points are respectively disposed at the middle positions of the first conductive element 101 and the second conductive element 102. The sensing points serving as the voltage sampling terminals and the first conductive elements 101 and the second conductive element 102 serving as the main current path of the current to be measured are both formed on the same conductor. The TCR of the resistor with this conventional structure is 63.46 ppm/K. In contrast, in one embodiment of the present invention, the first extension part 104 is made independently from the first conductive element 101, that is, the first extension part 104 is not in direct electrical contact with the first conductive element 101. The second extension part 105 is made independently from the second conductive element 102, that is, the second extension part 105 is not in direct electrical contact with the second conductive element 102. The TCR of the resistor 100 according to this embodiment is 6.29 ppm/K. That is, the TCR of the resistor 100 with the pins disposed on the side (offset arrangement) in this embodiment is significantly lower than that of the conventional resistor with the pins disposed in the center. In one embodiment, the first extension part 104 and the first conductive element 101 are not formed on the same conductor, and the second extension part 105 and the second conductive element 102 are not formed on the same conductor. The first extension part 104 and the second extension part 105 extend in a direction away from the resistive element 103, and the extension direction is not limited to whether it is parallel to the first conductive element 101, the second conductive element 102 or the main current direction D1.

In one embodiment, the resistive element 103 of the resistor 100 has a groove 131 formed on the first edge of the resistive element 103. The groove 131 extends from the first edge of the resistive element 103 toward the second edge of the resistive element 103. Preferably, the groove 131 is only disposed in the resistive element 103 and does not extend to or be disposed in the first extension part 104 and the second extension part 105. This configuration allows for an improvement in the TCR of the resistor 100 and provides a stronger structure for the first extension part 104 and the second extension part 105. Preferably, the groove 131 may be in an elongated shape and its extending direction is perpendicular (or not parallel) to the main current direction D1. In one embodiment, the resistive element 103 may further have another groove 132 formed on the second edge of the resistive element 103 opposite to the first edge. The another groove 132 extends from the second edge of the resistive element 103 toward the first edge of the resistive element 103. Preferably, the another groove 132 may be in an elongated shape and its extending direction is perpendicular to (or not parallel to) the main current direction D1, the extending direction of the first gap 134 or the extending direction of the second gap 135. The method of forming the groove 131 and the another groove 132 may be, for example, laser modification for partial removal, milling, punching, or other methods capable of removing material from the resistive element 103. The groove 131 or the another groove 132 has a depth which allows for the adjustment of the resistance of the resistor 100 so that the error associated with the resistance value of the resistor 100 is reduced. The first extension part 104 and the second extension part 105 are positioned equidistant from the resistive element 103 along the main current direction D1. That is, from the perspective of FIG. 2, the first extension part 104 and the second extension part 105 are located at the same level and maintain the same distance from the resistive element 103. In one embodiment, no groove is formed in the sides of the first conductive element 101 and the second conductive element 102, but only the sides of the resistive element 103 is formed with the groove 131 or the another groove 132.

In one embodiment, as shown in FIGS. 1 and 2, the first conductive element 101 is formed with a first locking hole 111, and the second conductive element 102 is formed with a second locking hole 112. Individual screws can be inserted into the first locking hole 111 and the second locking hole 112 of the resistor 100 to lock the resistor 100 in a battery module.

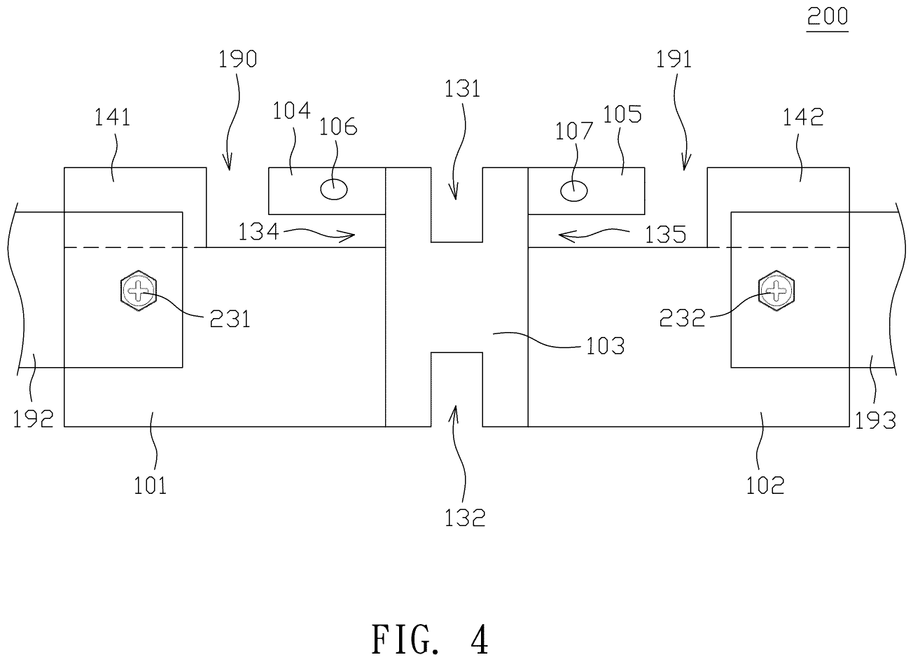

FIG. 4 is a top view of a resistor according to another embodiment. The embodiment of FIG. 4 is similar to the embodiment of FIG. 1, so the same elements use the same symbols or references and their related descriptions are omitted. Only at least one difference between the two embodiments will be described below. As shown in FIG. 4, the first conductive element 101 has a first protrusion 141, which extends outwardly from the first conductive element 101, is perpendicular (or not parallel to) the main current direction D1, and is located at the outer side of an end portion of the first conductive element 101. The second conductive element 102 has a second protrusion 142, which extends outwardly from the first conductive element 101, is perpendicular to (or not parallel to) the main current direction D1, and is located at an outer side of an end portion of the second conductive element 102. The first protrusion 141 and the second protrusion 142 are located on two opposite sides of the resistive element 103 and form accommodating spaces 190, 191 so that the first extension part 104 and the second extension part 105 are located in the accommodating spaces 190, 191. The first protrusion 141 and the second protrusion 142 do not directly contact the resistive element 103, the first extension part 104 and the second extension part 105. The first protrusion 141 and the second protrusion 142 are respectively located on corresponding sides of the first locking hole 111 and the second locking hole 112, respectively. When the electric conductive bus bar or wires 192, 193 on the battery or current path of the power system are secured to the first conductive member 101 adjacent to the first locking hole 111 and/or the second conductive member 102 adjacent to the second locking hole 112, by inserting and locking screws 231 and 232 into the first locking hole 111 and the second locking hole 112 of the resistor 100, the electric conductive bus bar or wires 192 may simultaneously contact the first conductive element 101 and the first protrusion 141 while the electric conductive bus bar or wires 193 may simultaneously contact the second conductive element 102 and the second protrusion 142. This configuration yields enhanced mechanical locking strength and reduced joint resistance.

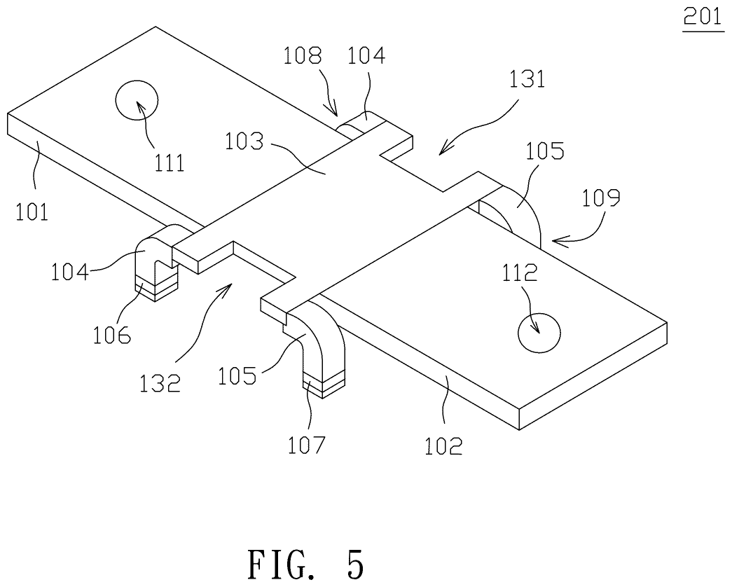

FIG. 5 is a perspective view of a resistor according to another embodiment. The embodiment of FIG. 5 is similar to the embodiment of FIG. 1, so the same elements use the same symbols or references and their related descriptions are omitted. Only at least one difference between the two embodiments will be described below. As shown in FIG. 5, the first extension part 104 and the second extension part 105 are respectively bent in the normal direction of the surface of the first conductive element 101 or the second conductive element 102. In this embodiment, the first extension part 104 and the second extension part 105 are bent downward from the first conductive element 101 or the second conductive element 102 respectively. The first extension part 104 and the second extension part 105 downwardly bent can negate the necessity for a pin structure, and the cost can be reduced. Moreover, the first extension part 104 and the second extension part 105 downwardly bent can directly pass through the welding holes of the detection circuit board, so it is easy to position them with the detection circuit board. In these embodiments, a portion of the first extension part 104 and the second extension part 105 can each be designated as the first sensing point 106, the second sensing point 107, the third sensing point 108, and the fourth sensing point 109 respectively.

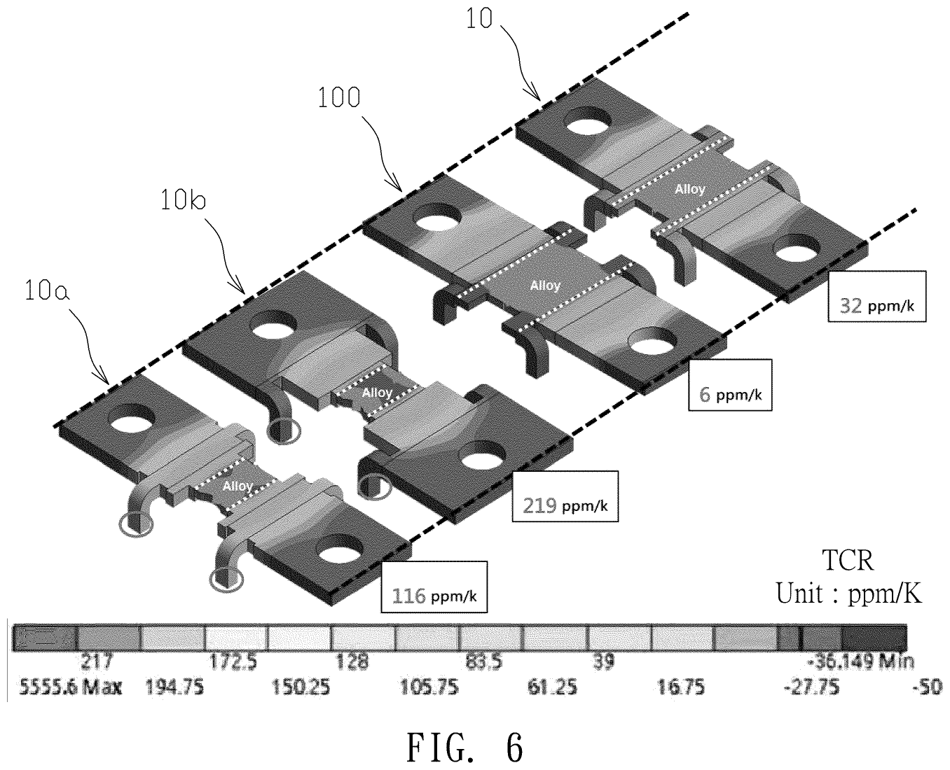

The TCR of the resistor 100 according to an embodiment of the present invention can be reduced by increasing the interval distance H1 of the first gap 134 or/and the interval distance H2 of the second gap 135 of the resistor 100. FIG. 6 is a TCR simulation diagram of resistors of comparative examples and a resistor according to an embodiment of the present invention. As shown in FIG. 6, the resistive elements of the resistor 10a, the resistor 10b, the resistor 10 and the resistor 100 are represented by the symbol “Alloy”, and their ranges are represented by dotted lines in FIG. 6. As comparative examples, the temperature coefficient of resistances (TCRs) of resistor 10a and resistor 10b are 116 ppm/k and 219 ppm/k respectively. In comparison, the temperature coefficient of resistance of the resistor 100 and resistor 10 according to an embodiment of the present invention is 6 ppm/k and 32 ppm/k. The interval distance H1 of the first gap 134 and the interval distance H2 of the second gap 135 of the resistor 10 are different from the interval distance H1 and the interval distance H2 of the resistor 100. The above illustrates that the resistors 10 and 100 of the present invention can optimize the resistance temperature coefficient of the resistors 10 and 100 by adjusting the interval distance H1 of the first gap 134 and the interval distance H2 of the second gap 135. It can be seen from the above that the resistors 10 and 100 according to an embodiment of the present invention can effectively reduce the temperature coefficient of resistance.

In the present invention, the first sensing point 106 and the second sensing point 107 may not be pins. In one embodiment, a sensing circuit of an external sensing printed circuit board may be adhered to the surface of the resistor 100 (by soldering with tin-containing solder). For example, the surface of resistor 100 is adhered to a sensing circuit on an external sensing printed circuit board. Furthermore, the sensing circuit of the printed circuit board is electrically connected to the first extension part 104 and the second extension part 105 through the first sensing point 106 and the second sensing point 107 which are serving as conductive paths.

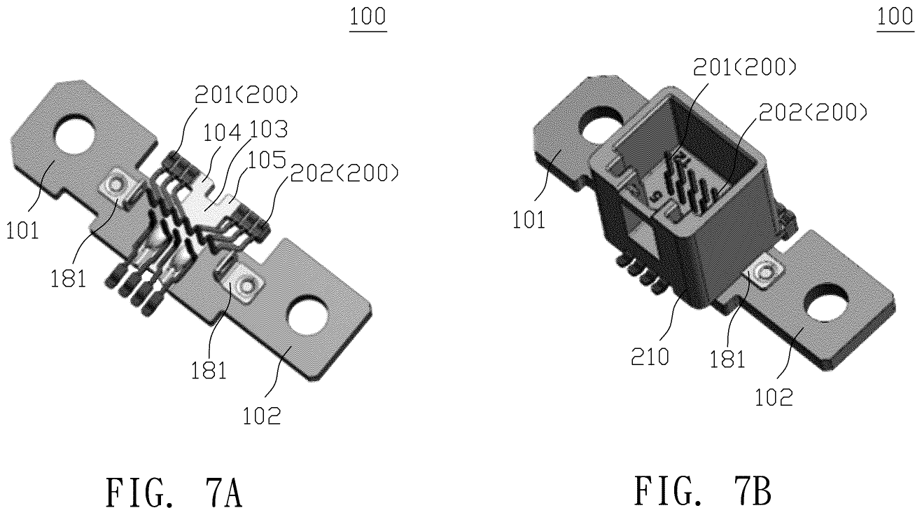

FIG. 7A is a perspective view of a resistor according to another embodiment. As shown in FIG. 7A, the resistor 100 further includes a conductive frame 200. The conductive frame 200 includes a first conductive lead-out structure 201 used as a first sensing point 106 and a second conductive lead-out structure 202 used as a second sensing pin 107. The first end of the first conductive lead-out structure 201 is welded (for example pressure fusion welding) or soldered with tin-containing solder (electrical bonding) to the first extension part 104, and the first end of the second conductive lead-out structure 202 is welded (for example pressure fusion welding) or soldered with tin-containing solder (electrical bonding) to the second extension part 105. The first conductive lead-out structure 201 and the second conductive lead-out structure 202 include a first end and a second end, and extend from the two first ends and across the first gap 134 and the second gap 135, respectively. Then, the first conductive lead-out structures 201 and the second conductive lead-out structure 202 extend to the middle part of the resistor 100, extend toward the normal direction of the surface of the resistor 100 to protrude from the surface of the resistor 100, and extend to their two second ends, respectively. The first conductive lead-out structure 201 and the second conductive lead-out structure 202 are used to connect to the current sensing device, for example, the current sensing unit of the vehicle management system, for detecting the magnitude of the current. FIG. 7B is a perspective view of a resistor according to another embodiment. In one embodiment, as shown in FIG. 7B, the resistor 100 further includes an electrical insulation housing 210, which is an injection molded structure and forms a connector with the conductive frame 200. The electrical insulation housing 210 is disposed on the surface of the middle part of the resistor 100 and is formed into a hollow shape. The middle part of the electrical insulation housing 210 defines an accommodation space, and the second ends of the first conductive lead-out structure 201 and the second conductive lead-out structure 202 are located within the accommodation space of the electrical insulation housing 210. The electrical insulation housing 210 can be easily and detachably connected to the connector of the current sensing device or connected to the connector of the wire assembly therein, so that the first conductive lead-out structure 201 and the second conductive lead-out structure 202 are used to connect to the current sensing device. In one embodiment, the resistor 100 further includes at least one reinforcing structure 181. One end of the reinforcing structure 181 is fixed to the first conductive member 101 or/and the second conductive member 102 (for example, fixed by pressure welding). The other end of the reinforcing structure 181 is encapsulated and fixed by the electrical insulation housing 210 (for example, fixed by injection molding).

According to the present invention, by using separate and independent paths for main current and voltage sampling, the rate of change at the voltage sampling point can be reduced. This reduces the temperature coefficient of resistance of the product and provides better product characteristics. More specifically, the first extension part 104 is not in direct contact with the first conductive element 101, the second extension part 105 is not in direct contact with the second conductive element 102, and the first extension part 104 and the second extension part 105 are used as voltage sensing terminals, so that the error amount in the detection voltage, detected at the voltage sampling point, caused by positional offsets due to fabrication can be reduced.

What is claimed is:

1. A resistor comprises:
a resistive element;
a first conductive element, connected to the first side of the resistive element;
a second conductive element, connected to the second side of the resistive element;
a first extension part, connected to the first side of the resistive element, extending in a direction away from the resistive element and spaced apart from the first conductive element;
a second extension part, connected to the second side of the resistive element, extending in a direction away from the resistive element and spaced apart from the second conductive element;
a first sensing point, located on the first extension part; and
a second sensing point, located on the second extension part.

2. The resistor of claim 1, wherein,
the first conductive element and the first extension part are welded to the first side of the resistive element,
the second conductive element and the second extension part are welded to the second side of the resistive element,
the welding structure on the resistive element between the first conductive element and the first extension part is partially or completely removed, and
the welding structure on the resistive element between the second conductive element and the second extension part is partially or completely removed.

3. The resistor of claim 2, wherein,
a first welding structure is formed between the resistive element and the first conductive element, a third welding structure is formed between the resistive element and the first extension part, and a first middle welding structure is connected between the first welding structure and the third welding structure,
a second welding structure is formed between the resistive element and the second conductive element, a fourth welding structure is formed between the resistive element and the second extension part, and a second middle welding structure is connected between the second welding structure and the fourth welding structure, and
the first middle welding structure or/and the second middle welding structure includes at least one groove, and the at least one groove faces a direction away from the resistive element.

4. The resistor of claim 2, wherein,
a first welding structure is formed between the resistive element and the first conductive element, a third welding structure is formed between the resistive element and the first extension part, and the first welding structure is spaced apart from the third welding structure,
a second welding structure is formed between the resistive element and the second conductive element, a fourth welding structure is formed between the resistive element and the second extension part, and the second welding structure is spaced apart from the fourth welding structure, and
a first notch or/and a second notch are located respectively on both sides of the resistive element.

5. The resistor of claim 4, wherein,
a first gap is formed between the first extension part and the first conductive element,
a second gap is formed between the second extension part and the second conductive element, and
the first notch and the second notch correspond to the first gap and the second gap respectively.

6. The resistor of claim 1, wherein,
a first gap is formed between the first extension part and the first conductive element, and
a second gap is formed between the second extension part and the second conductive element.

7. The resistor of claim 6, wherein,
the width of the first gap and the second gap is in the range of 1.0˜3.5 mm respectively.

8. The resistor of claim 1, wherein,
the resistive element has a groove formed on the first edge of the resistive element.

9. The resistor of claim 1, wherein,
the first conductive element is formed with a first locking hole, and the second conductive element is formed with a second locking hole.

10. The resistor of claim 1, wherein,
the first extension part and the second extension part are respectively bent toward the normal direction of the surface of the first conductive element or the second conductive element.

11. The resistor of claim 1, wherein,
the first sensing point and the second sensing point are pins.

12. The resistor of claim 1, further comprising a conductive frame and an electrical insulation housing forming a connector with the conductive frame, wherein,
the conductive frame includes a first conductive lead-out structure and a second conductive lead-out structure,
the first end of the first conductive lead-out structure is joined to the first extension part serves as the first sensing point;
the first end of the second conductive lead-out structure is joined to the second extension part serves as the second sensing point,
the electrical insulation housing is disposed on the surface of the resistive element and forms a hollow shape,
the electrical insulation housing defines an accommodating space, and the second ends of the first conductive lead-out structure and the second conductive lead-out structure are located in the accommodating space of the electrical insulation housing.

13. The resistor of claim 12, wherein, the electrical insulation housing is disposed on the surface of the middle part of the resistive element.

14. The resistor of claim 12, further comprising at least one reinforcing structure, wherein,
one end of the at least one reinforcing structure is fixed to the first conductive member and/or the second conductive member, and
the other end of the at least one reinforcing structure is encapsulated and fixed by the electrical insulation housing.
